(19) United States
(12) Patent Application Publication
(10) Pub. No.: US 2024/0055679 A1
(43) Pub. Date: Feb. 15, 2024

(54) MOBILE DEVICE FOR TREATING LITHIUM-ION ACCUMULATORS AND METHOD FOR THE TREATING LITHIUM-ION ACCUMULATORS

(71) Applicant: Riedhammer GmbH, Nurnberg (DE)

(72) Inventors: Matthias UHL, Sugenheim (DE); Dennis BIRD, Kunreuth (DE)

(73) Assignee: Riedhammer GmbH, Nurnberg (DE)

(21) Appl. No.: 18/229,279

(22) Filed: Aug. 2, 2023

(30) Foreign Application Priority Data
Aug. 10, 2022 (EP) 22189740.8

(51) Int. Cl. H01M 10/54

(52) U.S. Cl. CPC H01M 10/54; H01M 10/0525

(57) ABSTRACT

The invention relates to a mobile device for treating lithium-ion accumulators and to a method for treating lithium-ion accumulators.

### FIELD OF THE INVENTION

The invention relates to a mobile device for treating lithium-ion accumulators and to a method for treating lithium-ion accumulators.

### BACKGROUND OF THE INVENTION

A lithium-ion accumulator is the generic term for an accumulator based on lithium compounds. Such lithium-ion accumulators are also called lithium-ion accu or lithium-ion battery. Due to their high specific energy, lithium-ion accumulators are nowadays used for the electrical power supply of a wide variety of devices, for example smartphones, electric tools, electric gardening equipment, electric scooters, electric bicycles, electric forklifts, electric cars, stationary storage or other applications in the field of electromobility.

At the end of the service life of lithium-ion accumulators, it is recommended for ecological and economic reasons to recover many of the raw materials present in lithium-ion accumulators, such as lithium, cobalt, manganese, nickel, zinc, aluminum or copper. The same applies to waste material from the production of lithium-ion accumulators. According to legal regulations, there is also partly the obligation that lithium-ion accumulators are taken back by the manufacturer or distributor of the lithium-ion accumulators in order to be able to recycle the raw materials contained in them.

In order to be able to recover and recycle the raw materials present in lithium-ion accumulators, prior treatment of lithium-ion accumulators is necessary. Such treatment is usually carried out in industrial plants specially designed for this purpose. In order to treat lithium-ion accumulators in such plants for recovery of the raw materials present in them, lithium-ion accumulators are first collected by companies and institutions and then transported in batches to the plants in order to have the lithium-ion accumulators treated in these plants. However, such transportation is associated with high costs. Furthermore, such transport of lithium-ion accumulators poses a safety risk due to the high risk of fire and ignition of lithium-ion accumulators. For this reason, for example, according to the “European Agreement concerning the International Carriage of Dangerous Goods by Road” (ADR), any transport of lithium-ion accumulators is considered a transport of dangerous goods, for which special safety regulations apply.

### SUMMARY OF THE INVENTION

It is an object of the invention to provide a device for treating lithium-ion accumulators, in particular to be able to treat them in such a way that the substances present in the lithium-ion accumulators can subsequently be recovered, by means of which such transports of lithium-ion accumulators can be reduced.

In particular, it is an object of the invention to provide a mobile device for the treating lithium-ion accumulators. In doing so, the invention proceeds from the basic consideration of reducing transports of lithium-ion accumulators to devices for treating lithium-ion accumulators by not transporting the lithium-ion accumulators to the device, but rather by transporting the device to the lithium-ion accumulators in order to treat the lithium-ion accumulators by the device. Therefore, it is also a particular object of the invention to provide a device for treating lithium-ion accumulators that is mobile so that the device can be transported to the lithium-ion accumulators.

To solve these objects, according to the invention, there is provided a mobile device for treating lithium-ion accumulators, comprising the following features:
An input chamber, wherein lithium-ion accumulators are receivable in the input chamber;
a crushing device, wherein the lithium-ion accumulators received in the input chamber are conveyable from the input chamber to the crushing device, and the lithium-ion accumulators conveyed to the crushing device are crushable by the crushing device;
an intermediate charging container, wherein the lithium-ion accumulators crushed by the crushing device are conveyable from the crushing device to the intermediate charging container, and the crushed lithium-ion accumulators conveyed to the intermediate charging container are receivable in the intermediate charging container;
a rotary kiln, wherein the crushed lithium-ion accumulators received in the intermediate charging container are conveyable from the intermediate charging container into the rotary kiln, wherein the rotary kiln is electrically heatable, and wherein the crushed lithium-ion accumulators conveyed into the rotary kiln are thermally treatable by the rotary kiln; and
a discharge conveyor device, wherein the crushed lithium-ion batteries thermally treated in the rotary kiln are conveyable out of the rotary kiln by the discharge conveyor device.

The invention is based on the basic idea of providing a device for treating lithium-ion accumulators, by means of which lithium-ion accumulators can be treated in such a way that raw materials present in lithium-ion accumulators can be recovered after treatment, but at the same time the device is designed in such a way that it is mobile. All components of the device can therefore be designed and interact with each other in such a way that the device as a whole is mobile, i.e., can be transported in its entirety.

Due to this mobility or transportability of the device, it can be transported in its entirety. For example, the device can be transported to where lithium-ion accumulators to be treated are collected, so that they can be treated without being transported by the device according to the invention.

Preferably, the mobile device according to the invention is designed in such a way that it is mobile or transportable in its functional arrangement, i.e., without having to disassemble the device for transport.

According to a preferred embodiment, the mobile device is arranged in at least one mobile container, so that the device according to the invention is made mobile by the mobility or transportability of the at least one container. For example, the device can be arranged in two or more containers, wherein these containers can be coupled to one another, for example, in such a way that the device according to the invention results when the containers are coupled to one another.

According to a particularly preferred embodiment, the device according to the invention can be operated exclusively with electric current. In other words, the device according to the invention thus requires only a supply of electric current for its functionality and no further supply, such as a supply of gas, oil or water.

Preferably, therefore, all components of the device according to the invention are designed to be operable by electric current.

In order to be able to feed the lithium-ion accumulators to be treated by the device according to the invention into the device, the device according to the invention has an input chamber. Lithium-ion accumulators to be treated by the apparatus according to the invention can be received in this input chamber. In order to be able to input the lithium-ion accumulators into the input chamber, the input chamber preferably has an input opening through which lithium-ion accumulators can be input into the input chamber. According to a preferred embodiment, an inert gas atmosphere is adjustable in the input chamber. The adjustability of such an inert gas atmosphere in the input chamber has, in particular, the advantage that this can prevent reactive gases from entering through the input chamber into the components of the device according to the invention that are connected downstream of the input chamber. Preferably, an inert gas atmosphere based on nitrogen can be set in the input chamber. Preferably, it is provided that the input chamber can be closed in a gas-tight manner. This prevents reactive gases from entering the input chamber when an inert gas atmosphere is set in the input chamber. Preferably, the input chamber has a gas inlet for introducing inert gas into the input chamber. Preferably, the input chamber has an opening through which lithium-ion accumulators received in the input chamber can be conveyed into the crushing device downstream of the input chamber. Preferably, this discharge opening can be closed in a gas-tight manner.

A crushing device is connected downstream of the input chamber in the process direction. Lithium-ion accumulators received in the input chamber can be conveyed from the input chamber to the crushing device. According to a preferred embodiment, the lithium-ion accumulators accommodated in the input chamber can be conveyed from the input chamber to the crushing device by means of gravity. In particular, this also has the advantage that no separate conveying unit is necessary for conveying the lithium-ion accumulators from the input chamber to the crushing device, which enables additional compactness of the device and is thus conducive to the mobility of the device. To the extent that the input chamber has a closable discharge opening, as previously set forth, the lithium-ion accumulators received in the input chamber may be conveyable by gravity from the input chamber to the shredding device by opening the discharge opening. According to a preferred embodiment, the crushing device is arranged below the input chamber, whereby the lithium-ion accumulators can be conveyed particularly easily by gravity from the input chamber to the crushing device.

According to one embodiment, it is provided that the lithium-ion accumulators can be comminuted by the crushing device to a particle size, according to which at least 90% by mass of the lithium-ion accumulators comminuted by the crushing device have a particle size of at most 20 mm, particularly preferably at most 15 mm. As further explained below, the lithium-ion accumulators can preferably be thermally treated in the rotary kiln in such a way that they are at least partially pyrolytically decomposed. According to the invention, it has now been found that a sufficient pyrolytic decomposition is not or not regularly achievable if the lithium-ion accumulators are comminuted to a particle size of more than 20 mm or even only of more than 15 mm. According to the invention, it is therefore preferably provided, as stated above, that the lithium-ion accumulators are predominantly comminuted by the crushing device to a particle size below this critical size.

The particle size of the crushed lithium-ion accumulators can preferably be measured by means of sieve analysis.

According to a preferred embodiment, the crushing device comprises a single-shaft shredder. Single-shaft shredders, which are also referred to as single-shaft comminutor, are known from the prior art. Single-shaft shredders generally comprise a rotatable shaft on which rotor knives are circumferentially disposed. A cutting gap is formed between the shaft and an edge on which counter-knives are arranged. By rotation of the shaft, components in the cutting gap are comminuted by being cut between the rotor knives and the counter-knives in the cutting gap. According to the invention, it has surprisingly been found that lithium-ion accumulators can be shredded particularly advantageously by means of such a single-shaft shredder, and in particular also to particle sizes of at most 20 mm or of at most 15 mm. Furthermore, according to the invention, it has surprisingly turned out that such a size reduction to a maximum of 20 mm or 15 mm cannot be achieved by numerous other size reduction units available on the market, for example twin-shaft shredders. This applies in particular to the shredding of the polymer films regularly present in lithium-ion accumulators. According to a preferred embodiment, it is provided that the crushing device comprises a single-shaft shredder and a punch. The punch can be used to guide the lithium-ion batteries against the single-shaft shredder or the cutting gap of the single-shaft shredder. This makes it possible to achieve optimum comminution of the lithium-ion batteries in a particularly reliable manner, in particular to the aforementioned particle size. Preferably, the punch can be driven hydraulically.

The mobile device according to the invention has an intermediate charging container downstream of the crushing device in the process direction. The intermediate charging container is a container into which the lithium-ion accumulators crushed by the crushing device can be placed before the crushed lithium-ion accumulators are fed into the rotary kiln. The intermediate charging container thus also serves in particular as a buffer for the crushed lithium-ion accumulators between the crushing device and the rotary kiln. This effect of the intermediate charging container as a buffer also has the particular advantage that the mobile device according to the invention can be operated continuously, even if it is only charged with lithium-ion accumulators discontinuously or batchwise or the lithium-ion accumulators are only fed into the input chamber batchwise.

According to a preferred embodiment, it is provided that the lithium-ion accumulators crushed by the crushing device can be conveyed by means of gravity from the crushing device to the intermediate charging container. Such conveying by means of gravity also has in particular the advantage that a separate conveying device, by means of which the comminuted lithium-ion accumulators can be conveyed from the crushing device to the intermediate charging container, can be dispensed with. In particular, this also has the advantage of additional compactness and thus improved mobility of the device according to the invention. Preferably, the intermediate charging container is arranged below the crushing device, so that the crushed lithium-ion accumulators can be conveyed from the crushing device to the intermediate charging container particularly easily by gravity.

It has proven advantageous if at least 100 liters, particularly preferably at least 150 liters, of crushed lithium-ion accumulators can be accommodated by the intermediate charging container.

The rotary kiln of the apparatus according to the invention can be designed substantially like a prior art rotary kiln. Preferably, the rotary kiln comprises a rotary tube rotatably mounted about its longitudinal axis, the longitudinal axis being inclined to the horizontal. An inclination in the range between 0° and 3°, particularly advantageously between 1° and 3°, has been found to be advantageous according to the invention. The combustion chamber is formed inside the rotary kiln, in which the material to be fired can be thermally treated. By rotating the rotary kiln about the longitudinal axis, the material to be fired is automatically moved from the higher end of the rotary kiln to the lower end of the rotary kiln due to the inclination of the longitudinal axis. Material to be thermally treated in the rotary kiln is therefore moved at the upper end of the rotary kiln tube, the kiln inlet, to the lower end of the rotary kiln tube, the kiln outlet. Material to be fired is fed into the rotary kiln at the kiln inlet and discharged from the rotary kiln at the kiln outlet.

According to a preferred embodiment, it can be provided that the rotary tube has an internal helix. According to the invention, it has been found that this allows the crushed lithium-ion accumulators to be conveyed through the rotary kiln in a particularly advantageous manner during their thermal treatment.

According to a preferred embodiment, it can be provided that the rotary kiln tube has baffles projecting into the combustion chamber. According to the invention, it was found that the crushed lithium-ion accumulators can be mixed particularly advantageously by these baffles and heat can be transferred to them particularly well.

In the device according to the invention, the crushed lithium-ion accumulators conveyed into the rotary kiln can preferably be thermally treated by the rotary kiln in such a way that at least partial pyrolytic decomposition of the lithium-ion accumulators takes place. In such a pyrolytic decomposition, which is also referred to as pyrolysis, a thermo-chemical transformation is known to take place in which organic materials are split with the substantial exclusion of oxygen. Preferably, the thermal treatment in the rotary kiln takes place in an inert gas atmosphere, for which purpose an inert gas atmosphere can preferably be set in the rotary kiln. Preferably, an inert gas atmosphere based on nitrogen can be set. For setting such an inert gas atmosphere, an inert gas can preferably be introduced into the rotary kiln. Preferably, the rotary kiln has a gas inlet for this purpose, via which inert gas can be introduced into the rotary kiln. Preferably, the rotary kiln has such a gas inlet in the region of the kiln inlet, i.e., in the region in which material to be heated can be introduced into the rotary kiln.

Preferably, the rotary kiln has a gas outlet via which combustion gas (process gas) can be discharged from the rotary kiln. In particular, this combustion gas also includes the inert gas present in the rotary kiln and pyrolysis gases formed during the thermal treatment of the lithium-ion accumulators in the rotary kiln. The combustion gas discharged from the rotary kiln can preferably be fed to a post-treatment. In particular, thermal post-treatment of the combustion gases can be provided in order to render harmless, in particular, harmful components in the combustion gas.

Preferably, a temperature in the range between 250° C. and 650° C. can be set in the rotary kiln, i.e., in the rotary tube or in the combustion chamber of the rotary kiln. According to the invention, it has been found that complete pyrolysis of the lithium-ion accumulators that can be treated in the rotary kiln is not ensured if the temperature is below 250° C. Furthermore, according to the invention, it has been found that undesired partial melting of components of the lithium-ion accumulators can occur in the rotary kiln if the temperature exceeds 650° C. Particularly preferably, the rotary kiln can be set to a temperature in the range between 500° C. and 550° C. Preferably, the lithium-ion accumulators are thermally treated in the rotary kiln for a duration in the range of 10 to 150 minutes.

According to a particularly preferred embodiment, the rotary kiln is an indirectly heatable rotary kiln. As is known, in an indirectly heated rotary kiln, the heat is generated outside the rotary kiln and transferred via the rotary kiln tube to the combustion chamber inside the rotary kiln tube. According to the invention, it has been found that in a directly heated rotary kiln, in which the heat is generated inside the rotary kiln, in particular by gas burners, undesirable melting of the lithium-ion accumulators in the rotary kiln can occur, which can clog the rotary kiln or make thermal treatment of the lithium-ion accumulators more difficult. However, the use of an indirectly heated rotary kiln results in a particularly gentle thermal treatment of the lithium-ion accumulators in the combustion chamber, whereby such melting reactions can be suppressed. Particularly preferably, an electrically indirectly heatable rotary kiln is provided, the electrical heating preferably being effected by electrical heating elements or heating rods, especially preferably by silicon carbide heating rods, which are preferably arranged outside the rotary kiln. As known from the prior art, such an indirectly electrically heatable rotary kiln may comprise an externally insulated heating muffle, wherein the heating rods or heating elements may be arranged in the space between the rotary kiln tube and the heating muffle.

A particular advantage of such an indirectly electrically heatable rotary kiln according to the invention is that it must be connected to an electrical power supply alone for operation. An additional supply, for example of gas or oil, is not necessary. In this way, in particular, an objective according to the invention of operating the device according to the invention solely via an external electrical power supply can also be achieved.

The rotary kiln preferably operates on the direct current principle. In this respect, the rotary kiln is preferably set up in such a way that the lithium-ion batteries thermally treated in the rotary kiln and the kiln gases are guided from the inlet side to the outlet side of the rotary kiln or through the combustion chamber defined by the rotary kiln.

According to a preferred embodiment, it is provided that the mobile device according to the invention further comprises an input conveyor device, wherein the lithium-ion accumulators accommodated in the intermediate charging container can be conveyed by the input conveyor device from the intermediate charging container into the rotary kiln. Accordingly, the input conveyor device is designed in such a way that the crushed lithium-ion batteries held in the intermediate charging container or buffer can be conveyed by the input conveyor device from the intermediate charging container into the rotary kiln and then thermally treated there.

According to a particularly preferred embodiment, the input conveyor device comprises at least two screw conveyors. According to the invention, it has been found that the lithium-ion accumulators crushed by the crushing device, in particular insofar as they are predominantly crushed to a size of at most 20 mm or 15 mm, as previously explained, can very advantageously be transported by screw conveyors and conveyed into the rotary kiln. According to a further development of this inventive idea, the input conveyor device comprises at least a first screw conveyor, by means of which the comminuted lithium-ion accumulators can be conveyed out of the intermediate charging container, and a second screw conveyor, by means of which the comminuted lithium-ion accumulators can be conveyed into the rotary kiln. Preferably, the first and second screw conveyors are formed from such that the crushed lithium-ion accumulators conveyed by the first screw conveyor can be transferred to the second screw conveyor. An input conveyor device comprising at least two such screw conveyors has numerous advantages. First, two such screw conveyors can be movable relative to each other, allowing the second screw conveyor to be easily adjusted to a desired inclination of the rotary kiln. Further, however, this also allows the first and second screw conveyors to be formed from different materials. For example, the second screw conveyor can be made of high-strength steel that can withstand the harsh conditions at the inlet of the rotary kiln so that the second screw conveyor can convey the crushed lithium-ion batteries there into the rotary kiln. However, the first screw conveyor may be formed of a more favorable material, particularly a more favorable steel, that does not need to withstand such harsh conditions.

According to a preferred embodiment, it is provided that the rotary kiln comprises a rotary tube and an inlet housing, the rotary tube being sealed with respect to the inlet housing via a seal comprising polytetrafluoroethylene or a carbon ring seal. As known from the prior art, the inlet housing is preferably arranged in the area of the furnace inlet. Corresponding inlet housings are known from the prior art. They serve to receive material to be thermally treated in the rotary kiln before it is introduced into the rotary kiln. According to the invention, the crushed lithium-ion accumulators can preferably be conveyed into the inlet housing by the input conveyor device, particularly preferably by the second screw conveyor. Subsequently, the crushed lithium-ion accumulators conveyed into the inlet housing can be conveyed into the rotary kiln and can be thermally treated there.

According to a preferred embodiment, it can be provided that the rotary kiln comprises a cooling device in the region of the inlet housing. Such a cooling device can be designed in particular in such a way that the rotary kiln can be cooled by it in the region of its inlet housing. Preferably, the cooling device is designed in such a way that the rotary kiln can be cooled by gas, in particular by air, in the region of its inlet housing. It is particularly preferred that the cooling device is designed in such a way that the rotary kiln can be cooled by gas from the outside. Such a cooling device can in particular also prevent the polytetrafluoroethylene from thermally decomposing at higher temperatures.

According to a preferred embodiment, it is provided that the rotary kiln comprises a rotary tube and an outlet housing, the rotary tube being sealed with respect to the outlet housing via a seal comprising polytetrafluoroethylene or a carbon ring seal.

As known from the prior art, the outlet housing is preferably arranged in the area of the furnace outlet. Corresponding outlet housings are known from the prior art. They are used to accommodate material thermally treated in the rotary kiln after it has been discharged from the rotary kiln. In this process, material thermally treated in the rotary kiln is regularly fed into the outlet housing by the rotation of the rotary kiln. A technical challenge in prior art rotary kilns is the sealing of the rotary kiln tube against the outlet housing. This is because, while the outlet housing is regularly arranged in a fixed position, the rotary kiln tube is guided rotatably into the outlet housing. In accordance with the invention, it has now been surprisingly found that the rotary kiln of the mobile device according to the invention can be sealed very advantageously with respect to the outlet housing by means of a seal comprising polytetrafluoroethylene.

As previously explained, an inert gas atmosphere is preferably adjustable in the rotary kiln. According to a further development of this inventive idea, an inert gas atmosphere can preferably also be set in the components of the device downstream of the feed chamber in the process direction. This can prevent reactive gases from these components from entering the rotary kiln, where they could hinder pyrolysis of the lithium-ion batteries.

The discharge conveyor device of the mobile device according to the invention can basically be any conveyor known from the prior art, by means of which material treated in a rotary kiln can be conveyed out of the rotary kiln. According to a preferred embodiment, the discharge conveyor device comprises a rotary valve. Preferably, lithium-ion batteries thermally treated in the rotary kiln can be conveyed into the discharge conveyor device or the cellular wheel sluice of the discharge conveyor device, if necessary, via an outlet housing formed as described above. Preferably, the lithium-ion batteries can be conveyed by gravity into the discharge conveyor device, in particular into a rotary valve of the discharge conveyor device. This makes an additional conveying device unnecessary, which is conducive to the mobility of the device according to the invention.

According to a particularly preferred embodiment, the mobile device according to the invention further comprises an intermediate outlet container, wherein the lithium-ion batteries conveyed out of the rotary kiln by means of the discharge conveyor device can be accommodated in the intermediate outlet container. The intermediate outlet container is in this respect a buffer into which the thermally treated lithium-ion batteries conveyed out of the rotary kiln by the discharge conveyor device can be received before they are further treated or conveyed. This in turn enables the rotary kiln to be operated continuously, while the thermally treated lithium-ion batteries conveyed out of the rotary kiln can only be further treated or transported discontinuously, i.e., in batches.

According to one embodiment, it can be provided that the mobile device according to the invention comprises a screw conveyor through which the lithium-ion accumulators accommodated in the intermediate discharge container can be conveyed out. The screw conveyor can subsequently transfer the lithium-ion accumulators to any receiving device. According to a preferred embodiment, it is provided that the screw conveyor is cooled, preferably by means of a fluid, for example in the form of water or oil. Preferably, it is provided that the fluid is circulated and not consumed. The heat is preferably dissipated to the environment.

According to a preferred embodiment, it may be provided that the mobile device according to the invention comprises a device for generating inert gas. In particular, the device according to the invention may comprise such a device for generating gaseous nitrogen. A particular advantage of such a device for generating inert gas is, in particular, that the device according to the invention does not have to be connected to an external inert gas supply for its operation. Rather, the presence of such a device enables the device according to the invention to be operated solely by connection to an external power supply. The device for generating inert gas, in particular for generating gaseous nitrogen, can in principle be any device known from the prior art by means of which an inert gas, in particular gaseous nitrogen, can be generated. Particularly preferably, such a device is one which can be operated solely by means of connection to an external power supply. Preferably, the device is a nitrogen generator, particularly preferably a nitrogen generator based on the pressure swing principle with carbon molecular sieve. Preferably, the nitrogen generator is fed by a screw air compressor.

According to a further embodiment of the invention, it may be provided that the device further comprises a tank for storing the inert gas generated by the device for generating inert gas.

Furthermore, according to a further development of this inventive idea, it can be provided that the device comprises means for conducting inert gas from the tank to the rotary kiln, in particular into the rotary tube of the rotary kiln, in particular for introducing inert gas in the region of the kiln inlet. Furthermore, means may be provided for conducting inert gas from the tank into the input chamber.

Preferably, the mobile device according to the invention comprises control means by which the device is controllable. Preferably, these control means comprise an electronic data processing device by which the device can be controlled. In particular, the control means can be used to control or monitor the operation of all components of the device. In particular, the operation of the rotary kiln, i.e., in particular the temperature and the atmosphere of the rotary kiln, can be controllable or controlled by the control means.

It is also an object of the invention to provide a method for treating lithium-ion accumulators, comprising the following steps:
Providing a mobile device according to the invention;
input of lithium-ion accumulators into the input chamber;
conveying the lithium-ion accumulators fed into the input chamber to the crushing device;
crushing of the lithium-ion accumulators by the crushing device;
conveying the crushed lithium-ion accumulators into the intermediate charging container;
conveying the crushed lithium-ion accumulators conveyed into the intermediate charging container into the rotary kiln;
thermal treatment of the crushed lithium-ion accumulators conveyed into the rotary kiln by the rotary kiln;
conveying of the crushed lithium-ion accumulators thermally treated in the rotary kiln by the discharge conveyor device from the rotary kiln.

The method according to the invention is preferably carried out in such a way that the lithium-ion accumulators are treated as described above.

In this respect, the lithium-ion accumulators are preferably thermally treated by the rotary kiln, as previously explained, in such a way that at least partial pyrolytic decomposition of the lithium-ion accumulators takes place.

The lithium-ion accumulators thermally treated by means of the mobile device according to the invention, in particular by means of the method according to the invention, can subsequently be further treated in such a way that the aforementioned raw materials can be at least partially recovered from them.

Further features of the invention are apparent from the claims, the figures and the following accompanying figure description.

All features of the invention, individually or in combination, may be combined with one another in any desired manner.

### BRIEF DESCRIPTION OF THE DRAWINGS

An example of an embodiment of the invention is explained in more detail with reference to the attached, highly schematized figures and the associated, following figure description.

FIG. 1 shows a schematic process diagram of an embodiment of the device according to the invention and the method according to the invention; and

FIG. 2 shows a side view of the embodiment of the device according to FIG. 1.

### DETAILED DESCRIPTION OF THE INVENTION

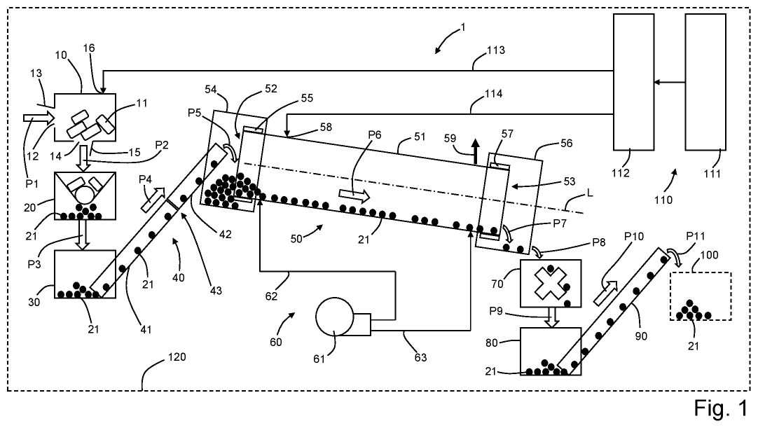

In its entirety, the mobile device in FIG. 1 is identified by the reference sign 1.

The device 1 comprises an input chamber 10, into which lithium-ion batteries 11 can be input according to arrow P1 via an input opening 12. The input opening 12 can be closed in a gas-tight manner via a first flap 13. On the underside, the input chamber 10 has an output opening 14 which can be closed in a gas-tight manner via a second flap 15. The input chamber 10 has a volume of 250 liters and can be closed gas-tight by means of the first and second flaps 13, 15. The input chamber 10 has a gas connection 16 for introducing inert gas into the input chamber 10. By introducing inert gas by means of the gas connection 16, an inert gas atmosphere can be set in the input chamber 10.

A crushing device 20 of the device 1 is arranged below the input chamber 10. The arrangement of the crushing device 20 below the input chamber 10 enables the lithium-ion accumulators to be conveyed by gravity from the input chamber 10 to the crushing device 20. By opening the second flap 15 of the input chamber 10, the lithium-ion accumulators located in the input chamber 10 fall by gravity into the crushing device 20. The crushing device 20 is a single-shaft shredder, in which material to be shredded is pressed against the shaft of the single-shaft shredder by means of a hydraulic ram. The single-shaft shredder is capable of crushing lithium-ion batteries to such an extent that they are almost completely present, and more than 90% by mass, in a particle size of no more than 15 mm. The conveying path of the lithium-ion accumulators from the input chamber 10 to the crushing device 20 is indicated by the arrow P2. The lithium-ion accumulators crushed by the crushing device 20 are indicated by black circles 21.

An intermediate charging container 30 is arranged below the crushing device 20. The intermediate charging container 30 is designed as a simple steel box and serves as a buffer between the input chamber 10 and crushing device 20 upstream in the process direction and the rotary kiln 50 downstream in the process direction. The arrangement of the intermediate charging container 30 below the crushing device 20 enables lithium-ion accumulators crushed in the crushing device 20 to fall by gravity from the crushing device 20 into the intermediate charging container 30, indicated by the arrow P3. The intermediate charging container 30 has a volume of about 150 liters.

The mobile device 1 further comprises a rotary kiln 50 and an input conveyor device 40, via which crushed lithium-ion accumulators received in the intermediate charging container 30 can be conveyed from the intermediate charging container 30 into the rotary kiln 50.

The rotary kiln 50 is in the form of a rotary kiln 50 which can be heated electrically indirectly via silicon carbide heating rods. The rotary kiln 50 comprises a cylindrical rotary tube 51 which is mounted rotatably about the central longitudinal axis L of the rotary tube 51. The central longitudinal axis L is inclined to the horizontal. The rotary tube 51 is made of a stainless, austenitic chromium-nickel-molybdenum steel with low carbon content. The higher end of the rotary kiln 51, on the left in FIG. 1, is the kiln inlet 52 of the rotary kiln 50, via which the crushed lithium-ion batteries to be thermally treated in the rotary kiln 50 can be fed into the rotary kiln 51. The lower end of the rotary kiln 51 on the right in FIG. 1 is the kiln outlet 53 of the rotary kiln 51, through which the lithium-ion batteries thermally treated in the rotary kiln 50 can be discharged from the rotary kiln 51. The rotary kiln 51 is insulated from the outside by a heating muffle (not shown), and the silicon carbide fuel rods (not shown) are arranged between the rotary kiln 51 and the heating muffle. The electrical heating of the rotary kiln 51 via the silicon carbide heating rods is carried out in accordance with the prior art. To this extent, the rotary tube 51 is heated from the outside via the heating rods, so that the heat is conducted via the rotary tube 51 into the space enclosed by the rotary tube 51. The space enclosed by the rotary kiln tube 51 thus serves as a combustion chamber in which the crushed lithium-ion batteries can be thermally treated. A control device controls the rotary kiln 50 in such a way that a temperature in the range of 500 to 550° C. prevails in the rotary kiln 51. In the region of the inlet 52, the rotary kiln 50 has an inlet housing 54 into which the rotary kiln 51 is partially introduced and with respect to which the rotary kiln 51 is sealed by a seal 55 comprising polytetrafluoroethylene. Similarly, in the region of the outlet 53, the rotary kiln 50 comprises an outlet housing 56 into which the rotary tube 51 is also partially inserted and with respect to which the rotary tube 51 is sealed by a seal 57 comprising polytetrafluoroethylene. The device 1 further comprises an air cooler 60, by means of which the rotary kiln 50 can be cooled in the region of the inlet 52 and the outlet 53 of the rotary tube 51. For this purpose, the cooler 60 comprises a fan 61, by means of which the rotary kiln 51 can be cooled from the outside in the region of the inlet 52 via a first cooling line 62 and the rotary kiln 51 can be cooled from the outside in the region of the outlet 53 via a second line 63 by blowing in air (fresh air). This allows the rotary tube 51 to be cooled in such a way that the seals 55, 57 comprising polytetrafluoroethylene can be protected from thermal damage.

The input conveyor device 40 comprises a first screw conveyor 41 and a second screw conveyor 42. By means of the first screw conveyor 41, crushed lithium-ion accumulators 21 located in the intermediate charging container 30 can be conveyed out of the intermediate charging container 30. At a transfer point 43, the first screw conveyor 41 transfers the crushed lithium-ion accumulators 21 to the second screw conveyor 42, via which the crushed lithium-ion accumulators 21 can finally be conveyed into the inlet housing 54 of the rotary kiln 50. The conveyance of the crushed lithium-ion accumulators 21 by the first and second screw conveyors 41, 42 is indicated by the arrow P4 and the entry of the crushed lithium-ion accumulators 21 from the second screw conveyor 42 into the inlet housing 54 is indicated by the arrow P5.

By rotating the rotary tube 51 around the central longitudinal axis L, the crushed lithium-ion accumulators 21 are transported from the inlet housing 54 into the rotary tube 51 and along the direction of arrow P6 through it to the outlet housing 56. During this passage through the rotary tube 51, the crushed lithium-ion accumulators 21 are thermally treated in such a way that they are pyrolytically decomposed. In order to provide the inert gas atmosphere necessary for such pyrolysis in the rotary kiln 51, the rotary kiln 51 has a gas feed 58 in the region of the inlet 52, via which inert gas can be introduced into the rotary kiln 51. The inert gas introduced into the rotary kiln 51 flows through the rotary kiln 51 in the direction of the arrow P6 as far as the region of the outlet 53, where the fuel gases, indicated by the arrow 59, are drawn off again from the rotary kiln 50. The withdrawn fuel gases can then be aftertreated by a fuel gas aftertreatment process not shown in the figures.

In the area of the outlet 53, the lithium-ion accumulators 21 pyrolyzed in the rotary kiln 51 fall by gravity into the outlet housing 56, indicated by the arrow P7, and from this in turn by gravity into a discharge conveyor device 70 in the form of a rotary valve. Below the rotary valve 70, an intermediate outlet container 80 in the form of a simple steel box is arranged as a buffer. Due to the arrangement of the intermediate outlet container 80 below the rotary valve 70, the thermally treated lithium-ion batteries 21 can fall by gravity from the rotary valve 70 into the intermediate outlet container 80, indicated by the arrow P9. Finally, the lithium-ion accumulators 21 can be conveyed along the direction of arrow P10 out of the intermediate outlet container 80 and into a transport container 100 via a further conveying screw 90, indicated by arrow P11. The screw conveyor 90 has a water-fed jacket cooling system so that the lithium-ion accumulators 21 can be cooled down to a maximum temperature of 60° C. during their transport through the screw conveyor 90.

Via the transport container 100, the crushed, thermally treated lithium-ion accumulators 21 can be removed in batches from the device 1 and fed to a further treatment. This batchwise removal is buffered by the intermediate outlet container 80.

The mobile device 1 further comprises means 110 for generating an inert gas in the form of gaseous nitrogen. The device 110 comprises an air screw compressor 111 by which gaseous nitrogen can be generated. Further, the device 110 comprises a gas tank 112 in which nitrogen gas generated by the air screw compressor 111 is receivable. From the gas tank 112, nitrogen can be introduced into the input chamber 10 via the gas opening 16 by means of a first inert gas line 113, on the one hand, and into the rotary tube 51 via the gas connection 58 by means of a second inert gas line 114, on the other hand.

All components of the device 1 can be driven by electric current, so that only a supply of electric current is required to operate the device 1.

Furthermore, the device 1 as a whole is designed in such a way that it is completely arranged in a container, indicated by the dashed line 120. By transporting the container 120, the entire device 1 as a whole is designed to be transportable or mobile.

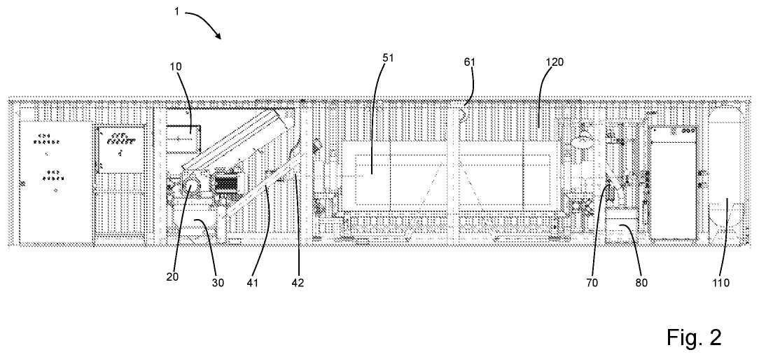

In FIG. 2, only some elements of the device 1 according to FIG. 1 are marked with reference signs.

Having described the invention, the following is claimed:

1. A mobile device for treating of lithium-ion accumulators, comprising:
an input chamber configured to accommodate lithium-ion accumulators;
a crushing device to which the lithium-ion accumulators accommodated by the input chamber are conveyed from the input chamber, the crushing device being configured to crush the conveyed lithium-ion accumulators;
an intermediate charging container to which the crushed lithium-ion accumulators are conveyed from the crushing device, the intermediate charging container being configured to receive the crushed lithium-ion accumulators therein;
a rotary kiln into which the crushed lithium-ion accumulators received in the intermediate charging container are conveyed from the intermediate charging container, the rotary kiln being electrically heatable and configured to thermally threat the crushed lithium-ion accumulators conveyed there into; and
a discharge conveyor device configured to convey the thermally treated lithium-ion accumulators out of the rotary kiln.

2. The mobile device according to claim 1, wherein an intergas atmosphere is set in the input chamber.

3. The mobile device according to claim 1, wherein the lithium-ion accumulators accommodated in the input chamber are conveyed from the input chamber to the crushing device by means of gravity.

4. The mobile device according to claim 1, wherein at least 90% by mass of the crushed lithium-ion accumulators have a particle size less than or equal to 20 mm.

5. The mobile device according to claim 1, wherein the crushing device comprises a single-shaft shredder.

6. The mobile device according to claim 1, wherein the crushed lithium-ion accumulators are conveyed from the crushing device to the intermediate charging container by means of gravity.

7. The mobile device according to claim 1, wherein the crushed lithium-ion accumulators are thermally treated by the rotary kiln in such a way that an at least partial pyrolytic decomposition of the crushed lithium-ion accumulators takes place.

8. The mobile device according to claim 1, further comprising:
an input conveyor device configured to convey the crushed lithium-ion accumulators received in the intermediate charging container into the rotary kiln.

9. The mobile device according to claim 8, wherein the input conveyor device comprises at least two screw conveyors.

10. The mobile device according to claim 1, wherein the rotary kiln comprises:
a rotary tube; and
an inlet housing, the rotary tube being sealed with respect to the inlet housing via a seal comprising polytetrafluoroethylene.

11. The mobile device according to claim 1, wherein the rotary kiln comprises:
a rotary tube; and
an outlet housing, the rotary tube being sealed with respect to the outlet housing via a seal comprising polytetrafluoroethylene.

12. The mobile device according to claim 1, further comprising:
an intermediate outlet container into which the thermally treated lithium-ion accumulators are conveyed out of the rotary kiln by the discharge conveyor device.

13. The mobile device according to claim 1, further comprising:
means for generating an intergas.

14. A method of treating lithium-ion accumulators, comprising:
inputting lithium-ion accumulators into an input chamber of a mobile device;
conveying the inputted lithium-ion accumulators to a crushing device of the mobile device;
crushing, via the crushing device, the conveyed lithium-ion accumulators;
conveying the crushed lithium-ion accumulators into an intermediate charging container of the mobile device;
conveying the crushed lithium-ion accumulators conveyed into the intermediate charging container into a rotary kiln of the mobile device;
thermally treating, via the rotary kiln, the crushed lithium-ion accumulators conveyed into the rotary kiln; and
conveying the thermally treated lithium-ion accumulators out of rotary kiln by a discharge conveyor device of the mobile device.

15. A method according to claim 14, wherein the crushed lithium-ion accumulators are thermally treated by the rotary kiln in such a way that an at least partial pyrolytic decomposition of the crushed lithium-ion accumulators takes place.
